(19) United States
(12) Patent Application Publication
(10) Pub. No.: US 2026/0086926 A1
(43) Pub. Date: Mar. 26, 2026

(54) TESTING OF DATA FOR DATA MIGRATION

(71) Applicant: DevRev, Inc., Palo Alto, CA (US)

(72) Inventors: Matija Ojo, Škofije (SI); Raško Pavlovic, Ljubljana (SI); Dragoslav Radin, Ljubljana (SI)

(73) Assignee: DevRev, Inc., Palo Alto, CA (US)

(21) Appl. No.: 18/891,270

(22) Filed: Sep. 20, 2024

(51) Int. Cl. G06F 11/36; G06F 16/21; G06F 16/27

(52) U.S. Cl. CPC G06F 11/3688; G06F 3/0647; G06F 11/3684; G06F 16/214; G06F 16/27; G06F 3/0619; G06F 16/2365

(57) ABSTRACT

Techniques for end-to-end testing of data migration from source platforms to a destination platform are described. A plurality of test data objects is generated based on a plurality of configuration files that defines rules by which the plurality of test data objects is generated. A predefined operation is applied to each of the plurality of test data objects to simulate data manipulation in a source platform. The first plurality of test data objects is mapped to corresponding data objects in the source platform and in a destination platform. The expected data for validation is computed. The expected data for validation includes expected data to be extracted from the source platform and the destination platform upon the data migration from the source platform to the destination platform. The data migration is validated by comparing data extracted from the first source platform and the destination platform against the computed data for validation.

### BACKGROUND

Generally, organizations deploy applications, such as Customer Relationship Management (CRM) based software applications, for various purposes. For instance, a CRM-based software application can market a product or a service provided by the organization to new customers, address issues raised by existing customers about products or services provided by the organization, provide technical support to the existing customers about the products and/or services provided by the organizations, handling customer sales using billing systems, and the like.

Each of the product development or services produces a stream of events that describe some activity or change thereof. The events are unique to each system, such as a product development system or a service system of the CRM-based software application. The events may reference one or more entities that span across the systems. A system of records includes events that are related to product development ecosystems, services ecosystems, or the like. Particularly, the system of records includes a high volume of events. For instance, the system of records may include events of objects, such as to track work about a product of a company, various operations being performed within a company, to track issues on an application developed using development tools, to track bugs in the application developed, to track interactions with users of product of companies, to track tickets raised by users, to track sales leads, potential customers, and the like.

### BRIEF DESCRIPTION OF DRAWINGS

The detailed description is provided with reference to the accompanying figures. In the figures, the leftmost digit(s) of a reference number identifies the figure in which the reference number first appears. The same numbers are used throughout the drawings to reference like features and components.

FIG. 1 illustrates a system for end-to-end data testing corresponding to data migration, according to an example implementation of the present subject matter.

FIG. 2 illustrates a system for end-to-end data testing corresponding to data migration, according to an example implementation of the present subject matter.

FIG. 3 illustrates a system for end-to-end data testing corresponding to data migration, according to an example implementation of the present subject matter.

FIGS. 4a and 4b illustrate a method for end-to-end data testing corresponding to data migration, according to an example implementation of the present subject matter.

FIG. 5 illustrates a method for end-to-end data testing corresponding to data migration, according to an example implementation of the present subject matter.

FIG. 6 illustrates a computing environment, implementing a non-transitory computer-readable medium for end-to-end data testing corresponding to data migration, according to an example implementation of the present subject matter.

Throughout the drawings, identical reference numbers designate similar elements, but may not designate identical elements. The figures are not necessarily to scale, and the size of some parts may be exaggerated to illustrate the example shown with better clarity. Moreover, the drawings provide examples and/or implementations consistent with the description; however, the description is not limited to the examples and/or implementations provided in the drawings.

### DETAILED DESCRIPTION

Conventionally, organizations use Customer Relationship Management (CRM) system to manage customer and client relationships. The CRM system may transmit or receive data for various purposes, such as storing a record about a client for a business, addressing a problem raised by a user regarding a product or a software application of the business, expanding the customer base of the business, and the like. Generally, the CRM system may have to be connected to various software applications, databases, Information Technology systems (IT systems), and one or more external CRM systems for optimizing the data flow across various platforms. For example, the CRM system may be connected to e-mail marketing platform, accounting software platform, sales data platform, and the like. This may ensure that the data is consistent and easily accessible throughout the organization. In this regard, the CRM system may have to receive data from one or more external platforms. Accordingly, data corresponding to a client for a business may have to be migrated from a source CRM system to a destination CRM system. In other words, data may have to be migrated from a CRM system, such as a Zendesk platform, to a CRM system, such as a Dev rev platform.

In some scenarios, a framework, such as Airdrop framework may be used for data migration and synchronization between two CRM systems. Specifically, when the data may have to be migrated to a CRM system, such as DevRev platform, from another CRM system, Airdrop framework may be used.

Generally, to ensure that the data from one CRM system is migrated completely into another CRM system without any issues, the data migration framework may have to be tested. Testing for the data migration includes manually creating, modifying, and deleting data in a system of records of a source CRM system. However, the manual process of testing for the data migration is a cumbersome process. Especially, given the volume of data for migration, in some scenarios, manual generation of test records may not be possible. Further, in some scenarios, the process of manually generating test records is often time-consuming and prone to errors. For instance, to verify the data, proper test data may have to be manually filled in. This may be challenging as wrong data may be filled in. Accordingly, the testing may not be valid and thereby, resulting in erroneous sign off for the data migration. Further, each of these CRM systems may have a business logic to accommodate data from an external CRM system. Therefore, conventionally, for the proper and complete data migration between CRM systems, each data may have to be manually checked for the application of business logic corresponding to the destination CRM system. The manual checking of the business logic is a difficult task.

Furthermore, conventionally, the testing is limited in the range of scenarios that could be tested. Accordingly, overall test coverage is reduced. Due to the reduced test coverage, handling a wide variety of data migration scenarios is difficult.

The present subject matter relates to end-to-end data testing of a data migration framework that is migrate data from source platforms to a destination platform. With the present subject matter, the generation of the test data and the expected results for the testing is automated. Accordingly, the present subject matter enables comprehensive and repeatable testing across multiple source systems of records.

In an implementation, a system for end-to-end data testing corresponding to data migration comprises a processor. The data migration framework may migrate the data from source platforms to a destination platform. In an example, the data migration framework may migrate the data from a first source platform and a destination platform and may be, for example, an Airdrop framework. The processor may generate a first plurality of test data objects based on a plurality of configuration files. Each test data object may include a set of attributes with assigned values. Each of the plurality of configuration files define rules by which the first plurality of test data objects is generated. A predefined operation is applied to each of the first plurality of test data objects to simulate data manipulation in a first source platform. The predefined operation may include at least one of: creation of at least one test data object, update of at least one test data object, and deletion of at least one test data object. The first source platform may be, for example, a CRM system, such as a Zendesk platform, JIRA platform, Hubspot, Salesforce platform, Freshdesk platform, and the like. The first source platform may include a first source system of records.

Further, the first plurality of test data objects may be mapped to corresponding data objects in the first source platform and in a destination platform. The destination platform may be, for example, DevRev platform. The destination platform may include a destination system of records.

Expected data for validation may be computed based on the application of the predefined operation and the mapping of the first plurality of test data objects. The expected data for validation comprises expected data that is to be extracted from the first source platform and the destination platform upon the data migration from the first source platform to the destination platform. The data migration may be validated by comparing data extracted from the first source platform and the destination platform against the computed data for validation. In an example, subsequent to the data validation, the system may generate a report indicating success or failure of the data migration based on the validation.

In an example, prior to the application of the predefined operation, the first plurality of test data objects may be loaded into the first source platform. The data migration may be invoked to transfer the first plurality of test data objects from the first source platform to the destination platform. The first plurality of test data objects may be transferred into the destination platform.

In another example, the plurality of configuration files comprises a metadata configuration file, a mapping configuration file, a low code configuration file, and a pools configuration file. The metadata configuration file may enable setting up testing environment. The mappings configuration file may define mapping of the first plurality of test data objects with the corresponding data objects in the first source platform and in the destination platform. The low code configuration file may facilitate the data migration from the first source platform to the destination platform. The pools configuration file may define templates for generating the first plurality of test data objects. In an example, the pools may include additional semantics to define complex templates for the first plurality of test data objects to enable the generation of test data objects with varying attributes and values to simulate different data migration scenarios. In an example, the plurality of configuration files is in Yet Another Markup Language (YAML) format.

In an example, the comparison of the data extracted from the first source platform against the computed data for validation for the first source platform may be performed prior to the invoking of the data migration to validate data in the first source platform. Further, the expected data for the destination platform may be computed to validate results of the data migration

The system may cyclically assign a plurality of values for each attribute within the first plurality of test data objects to perform comprehensive end-to-end data testing of the data migration. The system may automatically replicate a failed test scenario based on the validation of the data migration to enable debugging in the data migration.

In an example, the present subject matter may enable testing of data from a second source platform in addition to the first source platform. The second source platform may be different from the first source platform. For instance, the second source platform may be, for example, Zendesk platform, JIRA platform, Hubspot, Salesforce platform, Freshdesk platform, and the like. The second source platform may include a second system of records. A second plurality of test data objects may be generated based on the plurality of configuration files. Each test data object may include a set of attributes with assigned values. The plurality of configuration files defines rules by which the second plurality of test data objects is generated. A predefined operation may be applied to each of the second plurality of test data objects to simulate data manipulation in the second source platform. The predefined operation may include at least one of: creation of at least one test data object, update of at least one test data object, and deletion of at least one test data object. The second plurality of test data objects may be mapped to corresponding data objects in the second source platform and in the destination platform.

Data for validation may be computed based on the application of the predefined operation and the mapping of the plurality of test data objects. The data for validation may include expected data that is to be extracted from the first platform and the destination platform upon the data migration from the first platform to the destination platform. The data migration may be validated by comparing data extracted from the second source platform and the destination platform against the computed data for validation.

With the present subject matter, test data to facilitate end-to-end testing of data migration processes from one CRM system to another CRM system can be automatically generated and validated. By automatically generating and validating the test data, the present subject matter reduces time taken to conduct comprehensive regression tests, which are integral to ensuring that new changes do not adversely affect existing functionalities.

The present subject matter generates test data objects with a high degree of precision due to the use of configuration files. Specifically, the configuration files may include additional semantics, which enable the definition of complex data object templates. The complex data objects templates allow for the simulation of a wide range of data migration scenarios by varying the attributes and values of the test data objects. The flexibility of simulating wide range of data migration scenarios ensures that the data migration process can be thoroughly tested. The use of configuration files with additional semantics for defining test data objects allows for precise control over the test cases. The strict definition of the test data facilitates identifying gaps in the test coverage and provides a clear understanding of aspects of the data migration process that have been tested.

As mentioned earlier, the present subject matter applies predefined operations such as create, update, and delete to the test data objects, mapping these objects to the corresponding data objects in the source platforms and the destination platforms, and computing the expected results for the data validation. The process not only ensures that the data migration can be tested under diverse conditions but also facilitates the analysis of test coverage and the replication of failed test scenarios. By automating the testing process, the present subject matter enhances efficiency and reliability of regression testing. Further, the present subject matter provides the capability to generate an arbitrary amount of test data, and ensures the repeatability of tests, especially in case of failed test scenarios. Therefore, the present subject matter is instrumental in accelerating the development cycle and improving the quality of data migration processes. The present subject matter ensures that each test scenario is replicated exactly. Therefore, when a test scenario fails, the present subject matter automatically replicates the same scenario to verify the effectiveness of any corrective actions taken. The present subject matter, therefore, provides a robust and a reliable data migration, and thereby leads to higher quality software.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

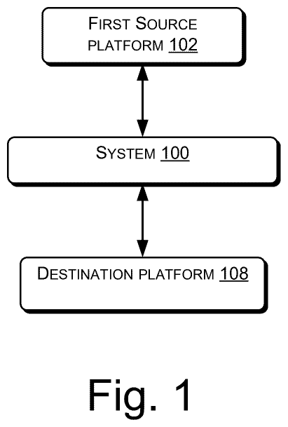

FIG. 1 illustrates a system 100 for end-to-end data testing corresponding to data migration, according to an example implementation of the present subject matter. Systems, such customer relationship management (CRM) systems, may transfer or receive data for different purposes, such as to send marketing e-mails to prospective customers, to solve issues raised by customers about the CRM system, and the like. Accordingly, the CRM systems may be connected to various software applications, platforms, databases, one or more CRM systems, and the like.

In this regard, the CRM systems that are to transmit the data may be referred to as the source platforms, such as the first source platform 102. In particular, the first source platform may be, for example, a CRM system, such as Zendesk platform, JIRA platform, Hubspot, Salesforce platform, Freshdesk platform, and the like. The first source platform may include a first source system of records (not shown in FIG. 1). The first source system of records may include events that are related to product development ecosystems, services ecosystems, or the like. Particularly, the system of records may include a high volume of events. For instance, the system of records may include events of objects, such as to track work about a product of a company, various operations being performed within a company, to track issues on an application developed using development tools, to track bugs in the application developed, to track interactions with users of product of companies, to track tickets raised by users, to track sales leads, potential customers, and the like. The destination platform 108 may be, for example, a CRM system, such as a DevRev platform. The data from the first source platform 102 may be migrated to the destination platform 108 for various purposes. Similar to the first source platform 102, the destination platform 108 may include a system of records (not shown in FIG. 1). The data may have to be migrated from the system of records of the first source platform 102 to the system of records of the destination platform 108. The data may be migrated using a data migration framework. In an example, the data migration framework may be Airdrop framework. In this regard, the data migration framework may have to be tested end-to-end for the data migration. Accordingly, the system 100 may facilitate end-to-end data testing of a data migration framework that is to migrate the data from the first source platform 102 to the destination platform 108. The system 100 may be a computing device that has processing capabilities, such as a server, a desktop, a laptop, a tablet, a mobile phone, or the like. For instance, the system 100 may include, for example, a microprocessor, a microcomputer, a microcontroller, a digital signal processor, a central processing unit, a state machine, a logic circuitry, or a device that manipulates signals based on operational instructions. The system 100 may include a processing unit (not shown in FIG. 1) and a memory (not shown in FIG. 1).

In an example, the system 100 may automatically generate test data objects for testing of data that is to be migrated from the first source platform 102 to the destination platform 108. In this regard, the system 100 may use a plurality of configuration files to generate the test data objects. Each test data object may be a set of attributes with each attribute having a value. In an example, the test data may be generated by application of a pre-defined operation on test data and mapping test data objects to corresponding objects in the system of records of the first source platform 102 and to corresponding objects in the system of records of the destination platform 108. Further, expected data for validation may be computed for the system of records of the first source platform 102 and for the system of records of the destination platform 108.

In the above-mentioned example, the data is explained to be migrated from the first source platform 102 to the destination platform 108. However, in addition to the first source platform 102, data may be migrated from a plurality of source platforms to the destination platform 108, as will be explained below.

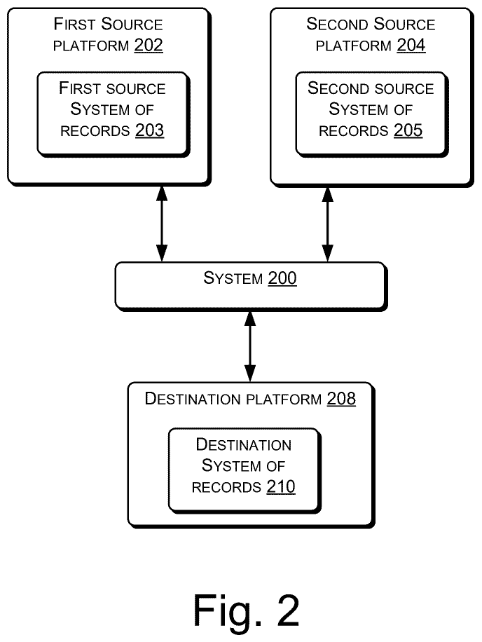

FIG. 2 illustrates a system 200 for end-to-end data testing corresponding to data migration, according to an example implementation of the present subject matter. The system 200 may correspond to the system 100. The CRM systems that are to transmit the data may be referred to as the source platforms, such as a first source platform 202 and a second source platform 204. The first source platform 202 may be, for example, a CRM system. In particular, the first source platform 202 may be, for example, a CRM system, such as Zendesk platform, JIRA platform, Hubspot, Salesforce platform, Freshdesk platform, and the like. The first source platform 202 may include a first source system of records 203. The first source system of records 203 may include events that are related to product development ecosystems, services ecosystems, or the like. Particularly, the first source system of records 203 may include a high volume of events. For instance, the first source system of records 203 may include events of objects, such as to track work about a product of a company, various operations being performed within a company, to track issues on an application developed using development tools, to track bugs in the application developed, to track interactions with users of product of companies, to track tickets raised by users, to track sales leads, potential customers, and the like. The first source platform 202 may correspond to the first source platform 102.

The second source platform 204 may be, for example, a CRM system. In particular, the second source platform 204 may be, for example, a CRM system, such as Zendesk platform, JIRA platform, Hubspot, Salesforce platform, Freshdesk platform, and the like. The second source platform 204 may include a second source system of records 205. The second source system of records 205 may include events that are related to product development ecosystems, services ecosystems, or the like. Particularly, the second source system of records 205 may include a high volume of events. For instance, the second source system of records 205 may include events of objects, such as to track work about a product of a company, various operations being performed within a company, to track issues on an application developed using development tools, to track bugs in the application developed, to track interactions with users of product of companies, to track tickets raised by users, to track sales leads, potential customers, and the like. The second source platform 204 may correspond to the first source platform 102.

The destination platform 208 may be, for example, a CRM system, such as a DevRev platform. The data from the first source platform 102 may be migrated to the destination platform 108 for various purposes. For instance, assume that the first source platform 202 is Zendesk platform and the second source platform 204 is Freshdesk platform. Further, assume that the destination platform 208 is DevRev platform. In this regard, the data corresponding to “admin users” in the Zendesk platform may have to be migrated to the DevRev platform as “Dev users” and the data corresponding to “customers” in the Freshdesk platform may have to be migrated as “contacts” in DevRev platform. Similarly, the data corresponding to “companies” in the Zendesk platform may have to be migrated to the DevRev platform as “Accounts” and the data corresponding to “tickets” in the Freshdesk platform may have to be migrated as “tickets” in DevRev platform.

Similar to the source platforms 202, 204, the destination platform 208 may include a system of records 210. The system of records 210 of the destination platform 208 may be referred to as destination system of records. The destination platform 208 may correspond to the destination platform 108.

In an example, the data may have to be migrated from the first source system of records 203 to the destination system of records 210 and from the second source system of records 205 to the destination system of records 210. In this regard, a data migration framework may facilitate migration of data from the first source system of records 203 and from the second source system of records 205 to the destination system of records 210. The data migration framework may be, for example, Airdrop framework. The data that is to be migrated may have to be tested end-to-end. Accordingly, the system 200 may facilitate end-to-end data testing of a data migration from the first source platform 202 to the destination platform 208 and from the second source platform 204 to the destination platform 208. The system 200 may be a computing device that has processing capabilities, such as a server, a desktop, a laptop, a tablet, a mobile phone, or the like. For instance, the system 200 may include, for example, a microprocessor, a microcomputer, a microcontroller, a digital signal processor, a central processing unit, a state machine, a logic circuitry, or a device that manipulates signals based on operational instructions. The system 200 may include a processing unit (not shown in FIG. 2) and a memory (not shown in FIG. 2).

In an example, the testing for the data migration from the first source system of records 203 to the destination system of records 210 and the testing for the data migration from the second source system of records 205 to the destination system of records 210 may be executed one after the other. In another example, the testing for the data migration from the first source system of records 203 to the destination system of records 210 and the second source system of records 205 to the destination system of records 210 may be executed simultaneously.

In an example, the system 200 may automatically generate test data objects for testing of data that is to be migrated from the first source platform 202 to the destination platform 208 and from the second source platform 204 to the destination platform 208. In this regard, the system 200 may use a plurality of configuration files to generate the test data objects corresponding to the data migration of each of the source system of records 203, 205. In an example, the test data may be generated by application of a pre-defined operation on test data and mapping test data objects to corresponding objects in the system of records 203, 205 and to corresponding objects in the destination system of records 210. Further, expected data for validation may be computed for the system of records of the first source platform 102 and for the system of records of the destination platform 108.

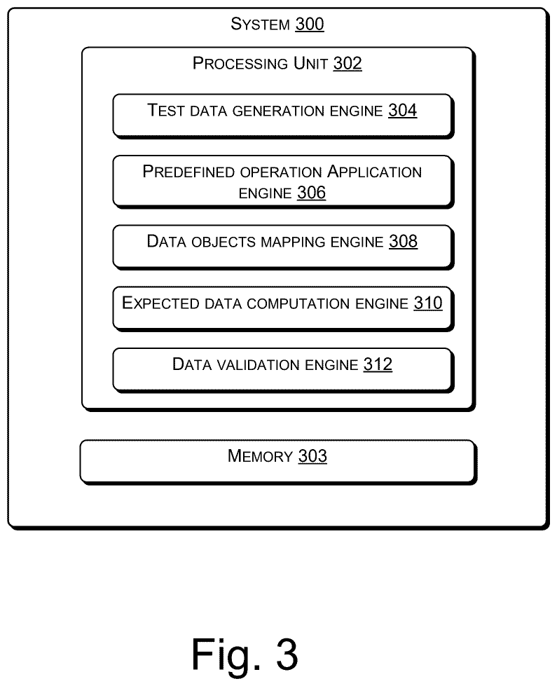

FIG. 3 illustrates a system 300 for end-to-end data testing corresponding to data migration, according to an example implementation of the present subject matter. The system 300 may correspond to the system 100 or the system 200. The system 300 may include a processing unit 302 and a memory 303. Among other capabilities, the processing unit 302 may fetch and execute computer-readable instructions stored in the memory 303, such as a volatile memory or a non-volatile memory, of the system 300. The data migration may be performed by a data migration framework, such as an Airdrop framework.

The processing unit 302 may run at least one operating system and other applications and services. The system 300 may also include an interface (not shown in FIG. 3). The processing unit 302, amongst other capabilities, may be configured to fetch and execute computer-readable instructions stored in the memory 303. The processing unit 302 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine readable instructions.

When provided by the processing unit 302, the functions may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the system 300 to interact with different entities, such as the source platforms 102, 202, 204 the destination platform 108, 208 and the data (not shown in FIG. 3). Further, the interface may enable the components of the system 300 to communicate with computing devices, web servers, and external repositories. The interface may facilitate multiple communications within a wide variety of networks and protocol types, including Local Area Network (LAN), wireless networks, wireless Local Area Network (WLAN), RAN, satellite-based network, and the like.

The memory 303 may be coupled to the processing unit 302 and may, among other capabilities, provide data and instructions for generating different requests. The memory 303 can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

Further, the system 300 can include one or more engines 304-312. The engines 304-312 may include routines, programs, objects, components, data structures, and the like, which perform particular tasks or implement particular abstract data types. Further, the engines 304-312 may be implemented in hardware, instructions executed by a processing unit, or by a combination thereof.

In an implementation, the engines 304-312 may be machine-readable instructions which, when executed by the processing unit 302, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 304-312 may perform different functionalities. The engines 304-312 may include a test data generation engine 304, pre-defined operation application engine 306, data objects mapping engine 308, expected data computation engine 310, and data validation engine 312.

The test data generation engine 304 may generate a first plurality of test data objects based on a plurality of configuration files. Each test data object may include a set of attributes with assigned values. The plurality of configuration files defines rules by which the first plurality of test data objects is generated. The first plurality of test data objects may correspond to the data migration from the first source system of records, such as the first source system of records 203, to the destination system of records, such as the destination system of records 210. In an example, the plurality of configuration files may include a metadata configuration file, a mappings configuration file, a low code configuration file, and a pools configuration file. The metadata configuration file may set up testing environment. The mappings configuration file may define mapping of the first plurality of test data objects with the corresponding data objects in the first source platform and in the destination platform. The low code configuration file may enable the data migration from the first source platform, such as the first source platform 102, or the first source platform 202, to the destination platform, such as the destination platform 108, or the destination platform 208. The pools configuration file may define templates for generating the first plurality of test data objects. In an example, the pools configuration file may include additional semantics to define complex templates for the first plurality of test data objects to enable the generation of test data objects with varying attributes and values to simulate different data migration scenarios.

For instance, the following may be a template for an object:
Issue:
Title: [A, B, C]
Body: [D, E]

In the above template, issue may be a test data object with attributes title and body. The data type of the attributes may be string. The attribute values of the Title attribute may be cyclically assigned between A, B, and C. Similarly, the attribute values of the body attribute may be cyclically assigned between D and E. In an example, multiple variations of attribute values of the same attribute may be defined and tested. For example, attribute values, such as empty string, a string of length 1, a string of length 10, a string with special characters, and the like, may be assigned and tested.

In an example, the test data generation engine 304 may generate a second plurality of test data objects for the data migration from the second source system of records, such as the second source system of records 205 to the destination system of records, such as the destination system of records 210. In this regard, the second plurality of test data objects may be generated based on the plurality of configuration files. The plurality of configuration files define rules by which the second plurality of test data objects may be generated.

The predefined operation application engine 306 may apply a predefined operation to each of the first plurality of test data objects to simulate data manipulation in the first source platform, such as the first source platform 102, or the first source platform 202. In an example, the predefined operation application engine 306 may apply a predefined operation to each of the second plurality of test data objects to simulate data manipulation in the second source platform, such as the second source platform 204. The predefined operation may include creation of at least one test data object, update of at least one test data object, and deletion of at least one test data object.

In an example, the predefined operation application engine 306 may load the first plurality of test data objects into the first source platform. Further, the predefined operation application engine 306 may invoke the data migration to transfer the first plurality of test data objects from the first source platform to the destination platform. In addition, the predefined operation application engine 306 may transfer the first plurality of test data objects into the destination platform. The predefined operation application engine 306 may load the second plurality of test data objects into the second source platform. Further, the predefined operation application engine 306 may invoke the data migration to transfer the second plurality of test data objects from the second source platform to the destination platform. In addition, the predefined operation application engine 306 may transfer the second plurality of test data objects into the destination platform. The data objects mapping engine 308 may map the first plurality of test data objects to corresponding data objects in the first source platform, such as the first source platform 102, or the first source platform 202, and to corresponding data objects in the destination platform, such as the destination platform 208. In addition, the data object mapping engine 308 may map the second plurality of test data objects to corresponding data objects in the second source platform, such as the second source platform 204 and to corresponding data objects in the destination platform.

For instance, assume that the first source platform is Zendesk platform and the destination platform is DevRev platform. Further, assume that the the data migration framework, such as the airdrop framework, is to migrate the data from the Zendesk platform to the DevRev platform. In particular, assume that the data corresponding to “tickets” from the Zendesk platform may have to be migrated to the DevRev platform as “tickets”. Accordingly, the following may be pools configuration file corresponding to “tickets” in Zendesk platform:

```
-name: zendesk_ticket_id
  values_template: { template: ticket_%i, start: 0, count: 10 }
- name: zendesk_ticket_subject
  values_template: { template: “Test Ticket %i”, start: 0, count: 10 }
- name: zendesk_ticket_description
  values_template: { template: “hardcoded_desc%i”, start: 0, count: 10 }
- name: zendesk_ticket_subject_forward_sync
  values_template: { template: “Test Ticket %i”, start: 10, count: 10 }
- name: zendesk_ticket_description_forward_sync
  values_template:
    {
      template: “hardcoded decsription forward_sync %i”,
      start: 10,
      count: 10,
    }
- name: zendesk_ticket_state
  values: [pending, solved]
- name: zendesk_ticket_priority
  values: [urgent, high, normal, low]
```

In the above template, Zendesk ticket may be a test data object with attributes Zendesk Ticket ID, Zendesk ticket subject, Zendesk ticket description, Zendesk ticket subject forward sync, and Zendesk ticket state. The data type of the attributes may be array of attributes. The attribute values of the comments attribute may be cyclically assigned. For instance, Zendesk ticket ID can be cyclically assigned between Ticket 0 and Ticket 10. Zendesk ticket subject can be cyclically assigned between Test Ticket 0 and Test Ticket 10. In an example, multiple variations of attribute values of the same attribute may be defined and tested.

Similarly, in the DevRev platform, the following may be the corresponding data for the pools configuration files:

```
- name: devrev_work_type
          values: [issue, opportunity, task, ticket]
- name: devrev_creator
          values: [dev-test-ad]
- name: devrev_stage
          values: [New]
- name: devrev_priorities
          values: [“high”, “medium”, “low”]
- name: devrev_custom_schema_fragments
          values: [problems, incidents, cases]
- name: devrev_ticket_title
          values_template: { template: “Test Ticket %i”, start: 0, count: 10 }
syncs:
  - sync_mode: initial
    operations:
operation_type: create
      external_system_type: zendesk
      entity_type: ticket
      template:
        count: 10
        start_id: 0
        fields_template:
            subject: $zendesk_ticket_subject
            description: $zendesk_ticket_description
            organization_id: $zendesk_organization_id
            requester_id: $zendesk_user_id # requester has to belong to the same
org as ticket
            assignee_id: $zendesk_default_user_id
            status: $zendesk_ticket_state
            priority: $zendesk_ticket_priority
```

A predefined operation of creating a Ticket is performed. The ticket may have attributes, such as subject, description, organization ID, a requester ID, assignee ID, status of the ticket, and a priority of the ticket.

Similarly, the above-mentioned mappings configuration file defines mapping of the test data objects with the corresponding data objects in the first source platform and in the DevRev platform. The mappings configuration file corresponding to the DevRev platform may be, for example, as follows:
Dev Test Ad: don:identity:dvrv-us-1:devo/<devOrgID>:devu/1
sysu_1: don:identity:dvrv-us-1:devo/<devOrgID>:sysu/1
   The mappings configuration file corresponding to the first source platform may be, for example, as follows:
“User_ID”: 9831782794525

Further, the low code configuration file facilitates the data migration from the first source platform to the DevRev platform. An example low code configuration file may be as follows:

```
forward_sync:
  low_code:
      issues, Task:
        priority:
          Crazy TEST prio: P0
reverse_sync:
  low_code:
    issues, Task:
        priority:
          P0: High
          P1: Medium
          P2: Low
        stage:
          Prioritized: In Progress
          In Deployment: In Progress
          In Development: In Progress
          In Review: In Progress
          In Testing: In Progress
          Awaiting Customer Response: In Progress
          Awaiting Development: In Progress
          Awaiting Product Assist: In Progress
          Duplicate: Done
          Completed: Done
          Won't Fix: Done
```

As mentioned above, based on the plurality of configuration files, the first plurality of test data objects and the second plurality of test data objects may be generated. Further, a predefined operation may be applied to each of the first plurality of test data objects and to each of the second plurality of test data objects. Yet further, the first plurality of test data objects may be mapped to corresponding data objects in the first source platform and to corresponding data objects in the destination platform. Similarly, the second plurality of test data objects may be mapped to corresponding data objects in the second source platform and to corresponding data objects in the destination platform.

The expected data computation engine 310 may compute expected data for validation based on the application of the predefined operation and the mapping of the first plurality of test data objects. The expected data for validation may include expected data that is to be extracted from the first source platform. In addition, the expected data for validation may include expected data that is to be extracted from the destination platform upon the data migration from the first source platform to the destination platform. In addition, in another example, the expected data computation engine 310 may compute expected data for validation based on the application of the predefined operation and the mapping of the second plurality of test data objects. The expected data for validation may include expected data that is to be extracted from the second source platform. In addition, the expected data for validation may include expected data that is to be extracted from the destination platform upon the data migration from the second source platform to the destination platform.

The data validation engine 312 may include extracting the data from the first source platform and from the destination platform upon the data migration from the first source platform to the destination platform. Further, the data validation engine 312 may include extracting the data from the second source platform and from the destination platform upon the data migration from the second source platform to the destination platform.

Further, the data validation engine 312 may compare data extracted from the first source platform and the destination platform against the computed data for validation corresponding to the first source platform and the destination platform. Based on the comparison, the data validation engine 312 may validate the data migration from the first source platform to the destination platform.

In another example, the data validation engine 312 may compare data extracted from the second source platform and the destination platform against the computed data for validation corresponding to the second source platform and the destination platform. Based on the comparison, the data validation engine 312 may validate the data migration from the second source platform to the destination platform. In an example, the data validation engine 312 may automatically replicate a failed test scenario based on the validation of the data migration to enable debugging in the data migration.

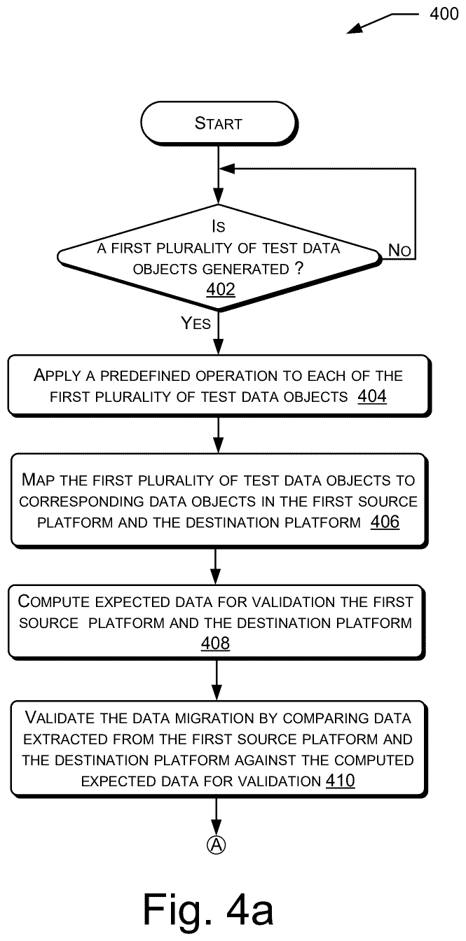

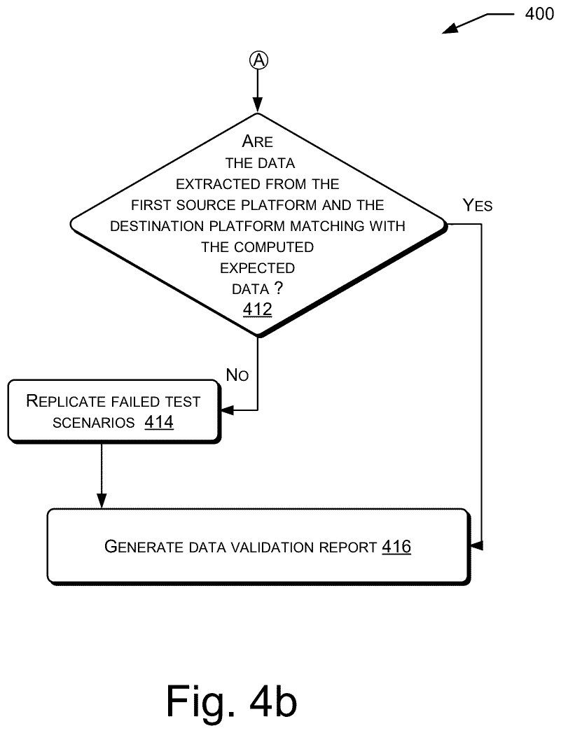

FIGS. 4a and 4b illustrate a method 400 for end-to-end data testing corresponding to data migration, according to an example implementation of the present subject matter. The order in which the method 400 is described is not intended to be construed as a limitation, and any number of the described method blocks may be combined in any order to implement the method 400, or an alternative method. Furthermore, the method 400 may be implemented by processor(s) or computing device(s) through any suitable hardware, non-transitory machine-readable instructions, or a combination thereof.

It may be understood that steps of the method 400 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 400 may be performed by the system 100, the system 200, or the system 300. Particularly, the method 400 may be performed by the processing unit, such as the processing unit 302. A data migration framework may enable migration of data from a first source platform to a destination platform. The data migration framework may be, for example, Airdrop framework.

At step 402, it may be determined if a first plurality of test data objects is generated. The first plurality of test data objects may correspond to the data migration from the first source platform to the destination platform. The first source platform may be, for example, the first source platform 102. The destination platform may be, for example, the destination platform 108, or the destination platform 208. In particular, the data may have to be migrated from first source system of records, such as the first source system of records 203, to the destination system of records, such as the destination system of records 205. The first plurality of test data objects may be generated based on the plurality of configuration files. The plurality of configuration files may include a metadata configuration file, mappings configuration file, low code configuration file, and pools configuration file. The metadata configuration file may facilitate setting up testing environment. The mappings configuration file may define mapping of the first plurality of test data objects with the corresponding data objects in the first source platform and with corresponding data objects in the destination platform. The low code configuration file may facilitate the data migration from the first source platform to the destination platform. The pools configuration file may define templates for generating the first plurality of test data objects. The pools may include additional semantics to define complex templates for the first plurality of test data objects to enable the generation of test data objects with varying attributes and values to simulate different data migration scenarios.

For instance, the following may be a template for an object:

```
Issue:
  comments:
    n_min-items : 0
    n_max-items : 5
  fields:
    Owner : [user 1, user 2]
    Content : [X, Y, Z]
```

In the above template, issue may be a test data object with attributes comments. The data type of the attributes may be array of attributes. The attribute values of the comments attribute may be cyclically assigned between 0 and 5. Each comment object may have the attributes owner and content. The attribute values of the owner attribute may be cyclically assigned between user 1 and user 2 and the attribute values of the owner attribute may be cyclically assigned between X, Y, and Z. In an example, multiple variations of attribute values of the same attribute may be defined and tested. In an example, each of the plurality of configuration files may be defined in Yet Another Markup Language (YAML).

If, at step 402, it is determined that the first plurality of test data objects is generated, the method 400 may proceed to step 404. If, at step 402, it is determined that the first plurality of test data objects is not generated, the method 400 may wait till first plurality of test data objects is generated. In an example, the step 402 may be performed by, for example, test data generation engine 304.

At step 404, a predefined operation may be applied to each of the first plurality of test data objects. The predefined operation may be a create operation, an update operation, and a delete operation. The create operation may correspond to the creation of at least one test data object. The update operation may correspond to executing changes in at least one test data object. The delete operation may correspond to removal of existing test data object.

In an example, prior to the application of the predefined operation, the first plurality of test data objects may be loaded into the first source platform. Particularly, the first test data objects may be loaded onto the first source system of records. The data migration of transfer of the first plurality of test data objects from the first source platform to the destination platform may be invoked. Further, the first plurality of test data objects may be transferred into the destination platform. In other words, the first plurality of test data objects may be transferred from the first source system of records to the destination system of records. In an example, the step 404 may be performed by, for example, predefined operation application engine 306.

At step 406, the first plurality of test data objects may be mapped to corresponding data objects in the first source platform and corresponding data objects in the destination platform. In an example, the step 406 may be performed by, for example, data objects mapping engine 308. At step 408, expected data for validation may be computed based on the application of the predefined operation and the mapping of the first plurality of test data objects. The expected data for validation may include expected data that is to be extracted from the first source platform and expected data that is to be extracted from the destination platform. The expected data for the destination platform may be computed to validate results of the data migration. In an example, the step 408 may be performed by, for example, expected data computation engine 310.

At step 410, data migration may be validated. For the validation, the data extracted from the first source platform may be compared with the expected data for validation corresponding to the first source platform. Similarly, the data extracted from the destination platform may be compared with the expected data for validation corresponding to the destination platform. In an example, the comparison of the data extracted from the first source platform against the computed data for validation for the first source platform may be performed prior to the invoking of the data migration to validate data in the first source platform.

At step 412, it may be ascertained if the data extracted from the first source platform matches with the computed expected data for validation corresponding to the first source platform. Further, it may be ascertained if the data extracted from the destination platform matches with the computed expected data for validation corresponding to the destination platform. If the data extracted does not match with the computed expected data, the method 400 may proceed to step 414. Alternatively, if the extracted data and the computed expected data matches at step 412, the method 400 may proceed to step 416.

At step 414, the failed test scenarios may be automatically replicated to enable debugging in the data migration. At step 416, the data validation report may be generated. In an example, the data validation report may indicate success or failure of the data migration based on the validation. In an example, the steps 410-416 may be performed by, for example, data validation engine 312.

In an example, the method 400 may enable testing data for data migration from a second source platform that is different from a first source platform. The second source platform may be, for example, the second source platform 204. Accordingly, the method 400 may include steps similar to 402-416. For instance, a second plurality of test data objects may be generated based on the plurality of configuration files. Each test data object comprises a set of attributes with assigned values. The plurality of configuration files defines rules by which the second plurality of test data objects is generated. A predefined operation may be applied to each of the second plurality of test data objects to simulate data manipulation in the second source platform. The predefined operation may include creation of at least one test data object, update of at least one test data object, and/or deletion of at least one test data object. The second plurality of test data objects may be mapped to corresponding data objects in the second source platform and in the destination platform. Expected data for validation may be computed based on the application of the predefined operation and the mapping of the second plurality of test data object. The expected data for validation may include expected data that is to be extracted from the second source platform and from the destination platform upon the data migration from the second source platform to the destination platform. The data migration may be validated by comparing data extracted from the second source platform and the destination platform against the computed data for validation corresponding to the second source platform and to the destination platform. In an example, if the data extracted matches with the computed expected data, data validation report indicating successful data validation may be generated. On the other hand, if the data extracted does not match with the computed expected data, failed test scenarios may be automatically replicated and the data validation report including successful or failed test validation may be generated.

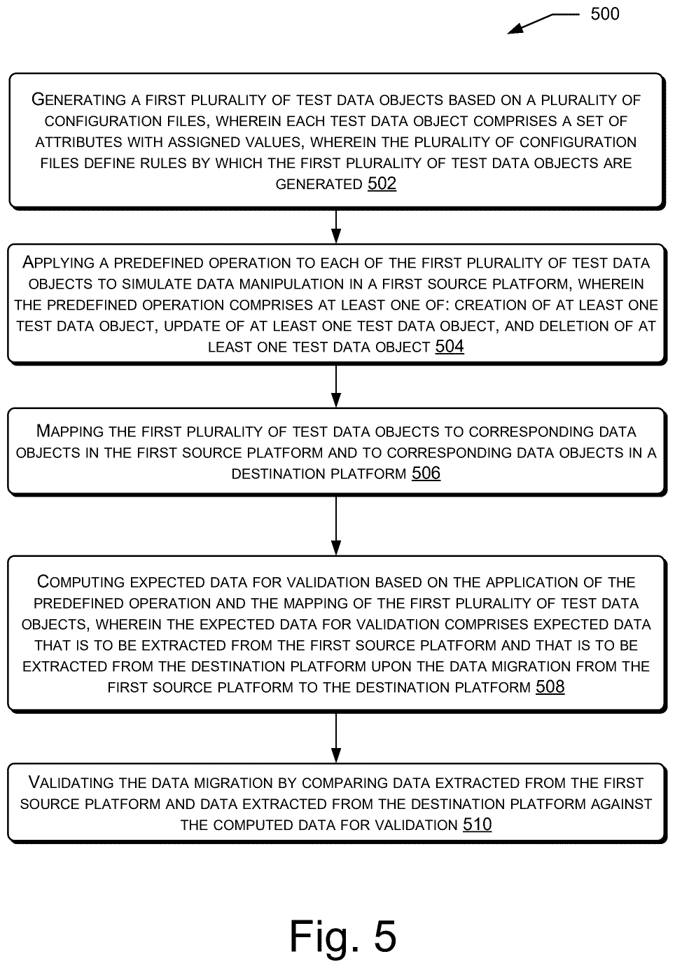

FIG. 5 illustrates a method 500 for end-to-end data testing corresponding to data migration, according to an example implementation of the present subject matter. The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media.

Herein, end-to-end data testing of data migration from source platforms to destination platform is explained. In an example, the method 500 may be performed by the system 100, the system 200, or the system 300. Particularly, the method 500 may be performed by the processing unit 302. A data migration framework may enable migration of data from a first source platform to a destination platform. The data migration framework may be, for example, Airdrop framework. The system may enable performing end-to-end data testing of the data migration framework.

At step 502, the method 500 may include generating, by a processor, a first plurality of test data objects based on a plurality of configuration files. Each test data object may include a set of attributes with assigned values. The plurality of configuration files defines rules by which the first plurality of test data objects is generated.

At step 504, a predefined operation may be applied to each of the first plurality of test data objects to simulate data manipulation in a first source platform. The predefined operation may include at least one of: creation of at least one test data object, update of at least one test data object, and deletion of at least one test data object. The first source platform may correspond to, for example, the first source platform 102, or the first source platform 202. The first source platform may include a first source system of records.

At step 506, the first plurality of test data objects may be mapped to corresponding data objects in the first source platform and to corresponding data objects in a destination platform. The destination platform may correspond to, for example, the destination platform 108 or the destination platform 208. The destination platform may include a destination system of records. At step 508, expected data for validation may be computed based on the application of the predefined operation and the mapping of the first plurality of test data objects. The expected data for validation may include expected data that is to be extracted from the first source platform and expected data that is to be extracted from the destination platform upon the data migration from the first source platform to the destination platform.

At step 510, the data migration may be validated by comparing data extracted from the first source platform and data extracted from the destination platform against the computed data for validation.

In an example, prior to the application of the predefined operation, the method 500 may include loading the first plurality of test data objects into the first source platform. Further, the data migration to transfer the first plurality of test data objects from the first source platform to the destination platform may be invoked. The first plurality of test data objects may be transferred into the destination platform.

The plurality of configuration files may include a metadata configuration file, a mappings configuration file, a low code configuration file, and a pools configuration file. The metadata configuration file may set up testing environment. The mappings configuration file may define mapping of the first plurality of test data objects with the corresponding data objects in the first source platform and corresponding data objects in the destination platform. The low code configuration file may facilitate the data migration from the first source platform to the destination platform. The pools configuration file may define templates for generating the first plurality of test data objects. The pools configuration file may include additional semantics to define complex templates for the first plurality of test data objects to enable the generation of test data objects with varying attributes and values to simulate different data migration scenarios. In an example, the method 500 may include cyclically assigning a plurality of values for each attribute within the first plurality of test data objects to perform comprehensive end-to-end data testing of the data migration.

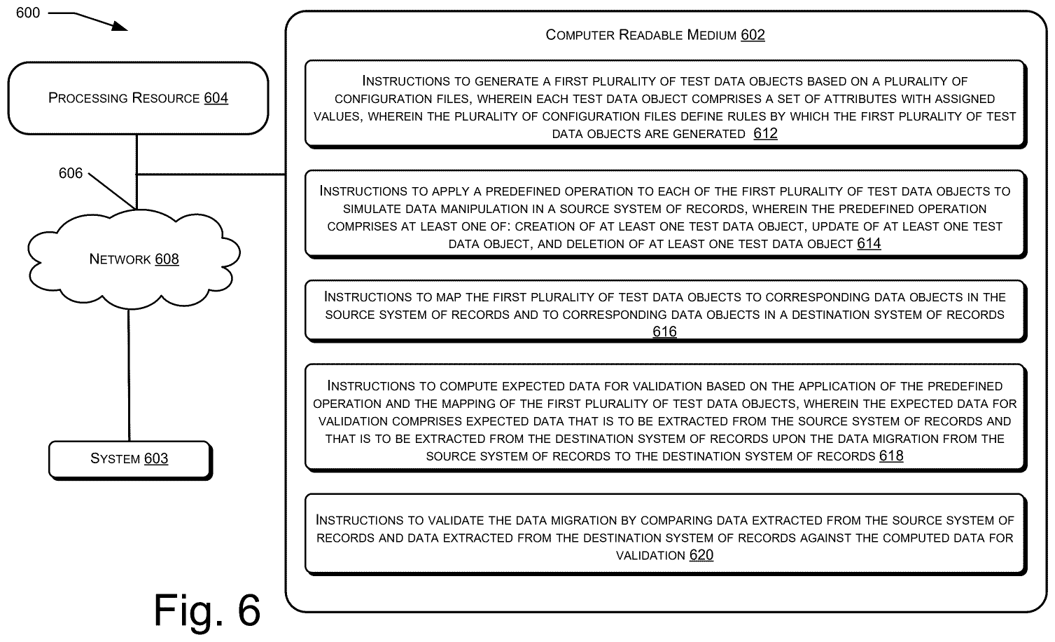

FIG. 6 illustrates a computing environment 600, implementing a non-transitory computer-readable medium for end-to-end data testing corresponding to data migration, according to an example implementation of the present subject matter.

In an example, the non-transitory computer-readable medium 602 may be utilized by the system 603. The system 603 may correspond to the system 100, the system 200, or the system 300. A data migration framework may enable migration of data from a first source platform to a destination platform. The data migration framework may be, for example, Airdrop framework. The system may enable performing end-to-end data testing of the data migration framework.

The system 603 may be implemented in a public networking environment or a private networking environment. In an example, the computing environment 600 may include a processing resource 604 communicatively coupled to the non-transitory computer-readable medium 602 through a communication link 606.

In an example, the processing resource 604 may be implemented in a device, such as the system 603. The non-transitory computer-readable medium 602 may be, for example, an internal memory device of the system 603 or an external memory device. In an implementation, the communication link 606 may be a direct communication link, such as any memory read/write interface. In another implementation, the communication link 606 may be an indirect communication link, such as a network interface. In such a case, the processing resource 604 may access the non-transitory computer-readable medium 602 through a network 608. The network 608 may be a single network or a combination of multiple networks and may use a variety of different communication protocols. The processing resource 604 and the non-transitory computer-readable medium 602 may also be communicatively coupled to the system 603 over the network 608.

In an example implementation, the non-transitory computer-readable medium 602 includes a set of computer-readable instructions to transform data forms in schemas for data transfer between different platforms. The set of computer-readable instructions can be accessed by the processing resource 604 through the communication link 606.

Referring to FIG. 6, in an example, the non-transitory computer-readable medium 602 includes instructions 612 to generate a first plurality of test data objects based on a plurality of configuration files. Each test data object may include a set of attributes with assigned values. The plurality of configuration files defines rules by which the first plurality of test data objects is generated.

The non-transitory computer-readable medium 602 includes instructions 614 to apply a predefined operation to each of the first plurality of test data objects to simulate data manipulation in a source system of record. The predefined operation may include at least one of: creation of at least one test data object, update of at least one test data object, and deletion of at least one test data object. The source system of records may correspond to the first source system of records 203 or the second source system of records 205.

The non-transitory computer-readable medium 602 includes instructions 616 to map the first plurality of test data objects to corresponding data objects in the source system of records and to corresponding data objects in a destination system of record. The destination system of records may correspond to, for example, the destination system of records 210.

The non-transitory computer-readable medium 602 includes instructions 618 to compute expected data for validation based on the application of the predefined operation and the mapping of the first plurality of test data objects. The expected data for validation comprises expected data that is to be extracted from the source system of records and expected data that is to be extracted from the destination system of records upon the data migration from the source system of records to the destination system of record.

The non-transitory computer-readable medium 602 includes instructions 620 to validate the data migration by comparing data extracted from the source system of records and data extracted from the destination system of records against the computed data for validation.

In an example, the plurality of configuration files comprises a metadata configuration file, a mappings configuration file, a low code configuration file, and a pools configuration file. The metadata configuration file may facilitate setting up testing environment. The mappings configuration file may define mapping of the first plurality of test data objects with the corresponding data objects in the source system of records and with the corresponding data objects in the destination system of record. The low code configuration file may facilitate the data migration from the source system of records to the destination system of record. The pools configuration file may define templates for generating the first plurality of test data objects. The pools configuration file may include additional semantics to define complex templates for the first plurality of test data objects to enable the generation of test data objects with varying attributes and values to simulate different data migration scenarios. The plurality of configuration files may be in YAML format.

The non-transitory computer-readable medium 602 includes instructions to automatically replicate a failed test scenario based on the validation of the data migration to enable debugging in the data migration.

With the present subject matter, test data to facilitate end-to-end testing of data migration processes from one CRM system to another CRM system can be automatically generated and validated. By automatically generating and validating the test data, the present subject matter reduces time taken to conduct comprehensive regression tests, which are integral to ensuring that new changes do not adversely affect existing functionalities.

The present subject matter generates test data objects with a high degree of precision due to the use of configuration files. Specifically, the configuration files may include additional semantics, which enable the definition of complex data object templates. The complex data objects templates allow for the simulation of a wide range of data migration scenarios by varying the attributes and values of the test data objects. The flexibility of simulating wide range of data migration scenarios ensures that the data migration process can be thoroughly tested. The use of configuration files with additional semantics for defining test data objects allows for precise control over the test cases. The strict definition of the test data facilitates identifying gaps in the test coverage and provides a clear understanding of aspects of the data migration process have been tested.

As mentioned earlier, the system applies predefined operations such as create, update, and delete to the test data objects, mapping these objects to the corresponding data objects in the source platforms and the destination platforms, and computing the expected results for the data validation. The process not only ensures that the data migration can be tested under diverse conditions but also facilitates the analysis of test coverage and the replication of failed test scenarios. By automating the testing process, the system enhances efficiency and reliability of regression testing. Further, the present subject matter provides the capability to generate an arbitrary amount of test data, and ensures the repeatability of tests, especially in case of failed test scenarios. Therefore, the present subject matter is instrumental in accelerating the development cycle and improving the quality of data migration processes. The present subject matter ensures that each test scenario is replicated exactly, especially when the test scenario fails. Therefore, when a test scenario fails, the present subject matter automatically replicates the same scenario to verify the effectiveness of any corrective actions taken. The present subject matter, therefore, provides a robust and a reliable data migration, and thereby, leading to higher quality software.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A system for end-to-end data testing corresponding to data migration from source platforms to a destination platform, the system comprising:
a processor to:
generate a first plurality of test data objects based on a plurality of configuration files, wherein each test data object comprises a set of attributes with assigned values, wherein the plurality of configuration files defines rules by which the first plurality of test data objects is generated;
apply a predefined operation to each of the first plurality of test data objects to simulate data manipulation in a first source platform, wherein the predefined operation comprises at least one of: creation of at least one test data object, update of at least one test data object, and deletion of at least one test data object;
map the first plurality of test data objects to corresponding data objects in the first source platform and in a destination platform;
compute expected data for validation based on the application of the predefined operation and the mapping of the first plurality of test data objects, wherein the expected data for validation comprises expected data that is to be extracted from the first source platform and the destination platform upon the data migration from the first source platform to the destination platform; and
validate the data migration by comparing data extracted from the first source platform and the destination platform against the computed data for validation.

2. The system of claim 1, wherein prior to the application of the predefined operation, the processor is to:
load the first plurality of test data objects into the first source platform;
invoke the data migration to transfer the first plurality of test data objects from the first source platform to the destination platform; and
transfer the first plurality of test data objects into the destination platform.

3. The system of claim 1, wherein the first source platform includes a first source system of records and the destination platform includes a destination system of records.

4. The system of claim 1, wherein the plurality of configuration files comprises:
a metadata configuration file to set up testing environment;
a mappings configuration file to define mapping of the first plurality of test data objects with the corresponding data objects in the first source platform and in the destination platform;
a low code configuration file for the data migration from the first source platform to the destination platform; and
a pools configuration file to define templates for generating the first plurality of test data objects.

5. The system of claim 4, wherein the pools configuration file comprises additional semantics to define complex templates for the first plurality of test data objects to enable the generation of test data objects with varying attributes and values to simulate different data migration scenarios.

6. The system of claim 2, wherein the comparison of the data extracted from the first source platform against the computed data for validation for the first source platform is performed prior to the invoking of the data migration to validate data in the first source platform.

7. The system of claim 2, wherein the expected data for the destination platform is computed to validate results of the data migration.

8. The system of claim 1, wherein the processor is to cyclically assign a plurality of values for each attribute within the first plurality of test data objects to perform comprehensive end-to-end testing of the data migration.

9. The system of claim 1, wherein the processor is to automatically replicate a failed test scenario based on the validation of the data migration to enable debugging in the data migration.

10. The system of claim 1, wherein the processor is to
generate a second plurality of test data objects based on the plurality of configuration files, wherein each test data object comprises a set of attributes with assigned values, wherein the plurality of configuration files defines rules by which the second plurality of test data objects is generated;
apply a predefined operation to each of the second plurality of test data objects to simulate data manipulation in a second source platform, wherein the predefined operation comprises at least one of: creation of at least one test data object, update of at least one test data object, and deletion of at least one test data object;
map the second plurality of test data objects to corresponding data objects in the second source platform and in the destination platform;
compute expected data for validation based on the application of the predefined operation and the mapping of the second plurality of test data objects, wherein the expected data for validation comprises expected data that is to be extracted from the second source platform and the destination platform upon the data migration from the second source platform to the destination platform; and
validate the data migration by comparing data extracted from the second source platform and the destination platform against the computed data for validation.

11. The system of claim 1, wherein the plurality of configuration files is in Yet Another Markup Language (YAML) format.

12. The system of claim 1, wherein the processor is to generate a report indicating success or failure of the data migration based on the validation.

13. A method for end-to-end data testing corresponding to data migration from source platforms to a destination platform, the method comprising:
generating a first plurality of test data objects based on a plurality of configuration files, wherein each test data object comprises a set of attributes with assigned values, wherein the plurality of configuration files defines rules by which the first plurality of test data objects is generated;
applying a predefined operation to each of the first plurality of test data objects to simulate data manipulation in a first source platform, wherein the predefined operation comprises at least one of: creation of at least one test data object, update of at least one test data object, and deletion of at least one test data object;
mapping the first plurality of test data objects to corresponding data objects in the first source platform and to corresponding data objects in a destination platform;
computing expected data for validation based on the application of the predefined operation and the mapping of the first plurality of test data objects, wherein the expected data for validation comprises expected data that is to be extracted from the first source platform and that is to be extracted from the destination platform upon the data migration from the first source platform to the destination platform; and
validating the data migration by comparing data extracted from the first source platform and data extracted from the destination platform against the computed data for validation.

14. The method of claim 13, wherein prior to the application of the predefined operation, the method comprises:
loading the first plurality of test data objects into the first source platform;
invoking the data migration to transfer the first plurality of test data objects from the first source platform to the destination platform; and
transferring the first plurality of test data objects into the destination platform.

15. The method of claim 13, wherein the first source platform includes a source system of records and the destination platform includes a destination system of records.

16. The method of claim 13, wherein the plurality of configuration files comprises:
a metadata configuration file to set up testing environment;
a mappings configuration file to define mapping of the first plurality of test data objects with the corresponding data objects in the first source platform and in the destination platform;
a low code configuration file for the data migration from the first source platform to the destination platform; and
a pools configuration file to define templates for generating the first plurality of test data objects, wherein the pools configuration file comprises additional semantics to define complex templates for the first plurality of test data objects to enable the generation of test data objects with varying attributes and values to simulate different data migration scenarios.

17. The method of claim 13, comprising:
cyclically assigning a plurality of values for each attribute within the first plurality of test data objects to perform comprehensive end-to-end testing of the data migration.

18. A non-transitory computer-readable medium comprising instructions for end-to-end data testing corresponding to data migration from source system of records to a destination system of record, the instructions being executable by a processing resource to:
generate a first plurality of test data objects based on a plurality of configuration files, wherein each test data object comprises a set of attributes with assigned values, wherein the plurality of configuration files defines rules by which the first plurality of test data objects is generated;
apply a predefined operation to each of the first plurality of test data objects to simulate data manipulation in a source system of record, wherein the predefined operation comprises at least one of: creation of at least one test data object, update of at least one test data object, and deletion of at least one test data object;
map the first plurality of test data objects to corresponding data objects in the source system of records and to corresponding data objects in a destination system of record;
compute expected data for validation based on the application of the predefined operation and the mapping of the first plurality of test data objects, wherein the expected data for validation comprises expected data that is to be extracted from the source system of records and that is to be extracted from the destination system of records upon the data migration from the source system of records to the destination system of record; and
validate the data migration by comparing data extracted from the source system of records and data extracted from the destination system of records against the computed data for validation.

19. The non-transitory computer-readable medium of claim 18, wherein the plurality of configuration files comprises:
a metadata configuration file to set up testing environment;
a mappings configuration file to define mapping of the first plurality of test data objects with the corresponding data objects in the source system of records and in the destination system of record;
a low code configuration file for the data migration from the source system of records to the destination system of record; and
a pools configuration file to define templates for generating the first plurality of test data objects, wherein the pools configuration file comprises additional semantics to define complex templates for the first plurality of test data objects to enable the generation of test data objects with varying attributes and values to simulate different data migration scenarios, and wherein the plurality of configuration files is in YAML format.

20. The non-transitory computer-readable medium of claim 18, the instructions being executable by a processing resource to automatically replicate a failed test scenario based on the validation of the data migration to enable debugging in the data migration.
